(19) United States
(12) Patent Application Publication
(10) Pub. No.: US 2006/0020630 A1
(43) Pub. Date: Jan. 26, 2006

(54) Facial database methods and systems

(76) Inventors: Reed R. Stager, Portland, OR (US); Tony F. Rodriguez, Portland, OR (US)

Correspondence Address: DIGIMARC CORPORATION, 9405 SW GEMINI DRIVE, BEAVERTON, OR, 97008, US

(21) Appl. No.: 11/146,896

(22) Filed: Jun. 6, 2005

Related U.S. Application Data
(60) Provisional application No. 60/590,562, filed on Jul. 23, 2004.

(51) Int. Cl. G06F 17/00

(52) U.S. Cl. 707/104.1

(57) ABSTRACT

Various arrangements for use of biometric data are detailed. For example, a police officer may capture image data from a driver license (e.g., by using a camera cell phone). Facial recognition vectors are derived from the captured image data corresponding to photo on the license, and compared against a watch list. In another arrangement, a watch list of facial image data is compiled from a number of government and private sources. This consolidated database is then made available as a resource against which facial information from various sources can be checked. In still another arrangement, entities that issue photo ID credentials check each newly-captured facial portrait against a consolidated watch list database, to identify persons of interest. In yet another arrangement, existing catalogs of facial images that are maintained by such entities are checked for possible matches between cataloged faces, and faces in the consolidated watch list database.

### RELATED APPLICATION DATA

This application claims priority to provisional application No. 60/590,562, filed Jul. 23, 2004.

### BACKGROUND AND SUMMARY

When making a traffic stop, a police officer commonly requests the stopped motorist's driver's license. By providing the license number to a database (either by ‘swiping’ the card through a reader which electronically forwards the data, or by verbally relaying the license number to a dispatch center), the officer can sometimes learn that the motorist has a warrant outstanding, or is otherwise a person of interest.

Typically, the officer also visually compares the photo on the license with the face of the driver, to ensure they correspond. The name on the license may also be compared with the name on vehicle registration or insurance documents, if solicited. (However, lack of correspondence can often be readily explained).

In accordance with one aspect of the technology detailed herein, these relatively rudimentary checks are augmented, e.g., by more sophisticated capture, and use, of the data carried by the driver's license. In one such arrangement, the officer captures image data from the license (e.g., by using a camera cell phone). Facial recognition vectors are derived from the captured image data corresponding to photo on the license, and compared against a watch list. If a possible facial match is identified, the motorist can be investigated further.

In accordance with another aspect of the technology detailed herein, a watch list of facial image data is compiled from a number of disparate sources, such as the Department of Homeland Security (faces of known terrorists), the Federal Bureau of Investigation (FBI's Wanted posters), and agencies charged with searching for missing children. This consolidated database is then made available as a resource against which facial information from various sources can be checked.

In accordance with still another aspect of the technology detailed herein, entities that issue photo ID credentials—such as state departments of motor vehicles, the passport issuing service of the U.S. State Department, and badging authorities for federal workers—check each newly-captured facial portrait against the consolidated watch list database, to identify persons of interest.

In accordance with yet another aspect of the technology detailed herein, existing catalogs of facial images that are maintained by such credentialing entities are checked for possible matches between cataloged faces, and faces in the consolidated watch list database.

The foregoing and additional features and advantages will be more readily apparent from the following detailed description, which proceeds by reference to the accompanying drawings.

### BRIEF DESCRIPTION OF THE DRAWINGS

FIG. 1 is a block diagram showing aspects of certain embodiments described herein.

FIG. 2 is a diagram showing arrangement of an exemplary database used in the system of FIG. 1.

### DETAILED DESCRIPTION

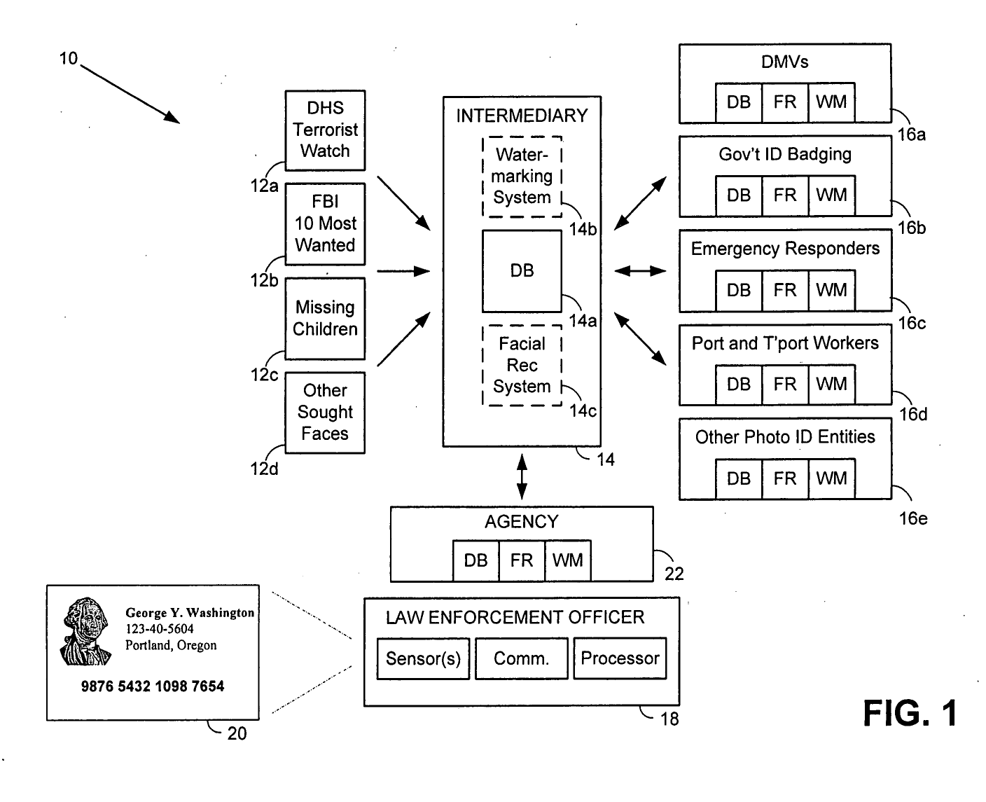

Referring to FIG. 1, the principal parts of one of the systems 10 detailed herein include sources 12 of sought-for facial data, an intermediary 14, and a variety of photo ID issuers 16. This infrastructure may be utilized by law enforcement personnel 18, and law enforcement agencies 22, when considering a driver's license 20 or other source of image data.

Illustrated sources 12 of facial data include the Department of Homeland Security, the FBI, and agencies charged with locating missing children. However, these sources are simply exemplary; others can naturally be added or substituted.

The intermediary 14 can be an agency or service that collects and consolidates facial image data from a variety of sources of facial data.

One reason the intermediary 14 is desirable is to provide a single resource that the issuers 16 of photo IDs, and law enforcement 18, can consult with regard to facial image data. Additionally, the intermediary can provide a consistent set of technical standards, such as image compression, facial feature vectors, user interfaces, etc., to its users—converting as necessary—rather than letting the users confront a babble of diverse technologies and standards. (It will be recognized that the intermediary is not strictly essential, and many advantages from the technology detailed herein can be achieved without this element. Moreover, in some instances it may be desirable to have several intermediaries, e.g., specialized to different images types or geographies, or for redundancy, etc.)

A primary function of intermediary 14 is to provide a database 14a into which facial data from sources 12 can be compiled, and from which facial data can be provided to users for matching purposes. (The facial data typically comprises facial images, e.g., in JPEG, JPEG2000, TIF, or other form. However, the database can additionally, or alternatively, serve as a repository for ‘faceprint’ data, as more particularly detailed below.)

In addition to providing a database for facial data, intermediary 14 can include a variety of other components.

One such component is a watermarking system 14b. Watermarking systems are known, so the technology per se is not belabored here. (See, e.g., commonly owned Pat. No. 6,614,914, which details a variety of suitable image watermarking technologies.) One use of the watermarking system by intermediary 14 is to associate metadata with each facial image received from sources 12 and entered into the database 14a. This metadata can include identification of the image source, date of receipt, date of original image capture, name of the depicted individual, date of birth, etc. This data can be literally embedded in the image, but more commonly is stored in a database (e.g., a table in database 14a) and indexed by a number that is embedded in the image. (Use of watermarking systems in meta data systems is more particularly detailed in published application U.S. 20020001395.)

Intermediary 14 can additionally include one or more facial recognition (“FR”) components 14c. Such components encode—typically in a template—certain distinguishing features of facial images, to facilitate later facial matching. (The resulting set of data is termed a ‘faceprint’ herein.) A brief survey of such technologies is provided in Appendix A. Exemplary systems are detailed in Pat. Nos. 6,563,950, 6,466,695, and 6,292,575. Since different users of the database may employ different facial recognition systems, intermediary 14 may include several different such systems 14c, so as to provide compatibility with different user requirements.

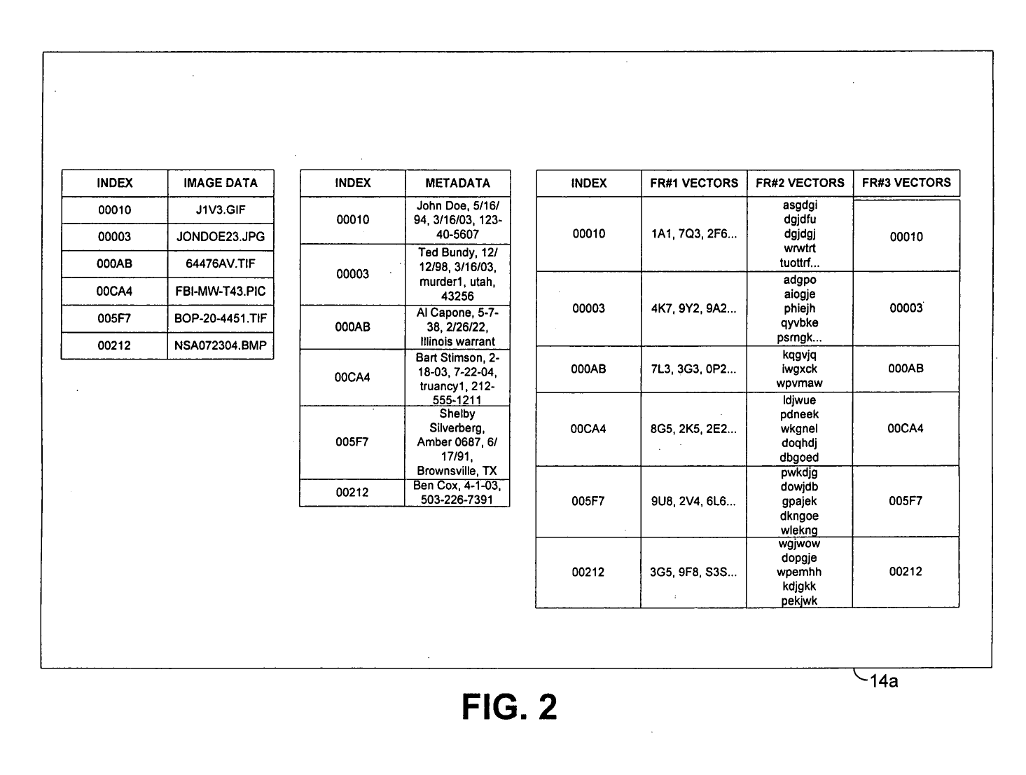

FIG. 2 shows an illustrative database 14a, including various tables. Each is indexed with an indexing identifier, which is common across the tables. The first table associates the indexing identifier with facial image data—as received from the agencies 12. The second associates the indexing identifier with metadata. This metadata can be provided by the agency 12 that provided the facial data, and may be supplemented over time using other sources. This third table associates the indexing identifier with faceprints for the image—computed according to a number of different algorithms. Thus, FR#1 may be a facial recognition technology employed by Colorado and Massachusetts. FR#2 may be a facial recognition technology by federal immigration agencies, etc., etc. (Some of this faceprint data may be provided from agencies 12, or it may be generated by the intermediary each time facial image data is received.)

It will recognized that the database of FIG. 2 is presented to foster general understanding of the technology; a great number of different implementations are of course possible.

The depicted system includes various issuers 16 of photo ID credentials, such as state DMVs, state, federal and military ID badging services, port and transportation workers, emergency responders, etc. Such issuers may use a variety of diverse systems to capture facial portraits, generate corresponding faceprint data, and issue ID documents. Exemplary systems are detailed in copending applications 60/586,023 (filed Jul. 6, 2004), and Ser. No. 11/112,965 (filed Apr. 22, 2005, which claims priority to application 60/564,820, filed Apr. 22, 2004), and in published U.S. applications 20050068420, 20050031173, and 20040213437. Although the issuance systems can each employ diverse components, they are each shown in FIG. 1 as including a database (DB), a facial recognition system (FR), and a watermarking system (WM).

To illustrate one novel use of this technology, consider the following exemplary sequence of events. The FBI adds a person to its 10 Most Wanted List, and transmits a copy of the person's facial image—together with associated metadata—to the intermediary 14. The intermediary 14 watermarks the image using watermarking system 14b, and stores the image in the database 14a—together with the linked metadata. Intermediary 14 may also generate faceprints using different FR algorithms, and store these in the database too.

Each time a credentialing authority 16 is requested to issue a photo ID, a faceprint corresponding to the applicant is generated, and checked against faceprints in the database 14a. If the faceprint indicates a likely match with a person wanted by the FBI, then the matter can be further investigated. For example, the credential issuing authority can delay issuance of the credential, or can solicit additional identification from the applicant (e.g., a fingerprint) that may help confirm or refute a match. A notification of the potential match may be flagged to personnel at the intermediary 14, and/or may be noted directly to personnel at a law enforcement agency, including (but not limited to) the one that provided the image (i.e., the FBI).

By the foregoing procedure, each time a person applies for a photo ID through one of the participating credentialing entities, data characterizing his or her face can be compared against a library data corresponding to sought-for faces, triggering follow-up action if appropriate.

For privacy reasons, it is preferable that the facial images of applicants not leave the custody and control of the credentialing entities 16. One way to achieve this aim is for the credentialing agency to compute the faceprint, and send only this data to the intermediary 14, where it is screened against the database 14a. Another way is for the intermediary to send its library of sought-for faceprints to the credentialing agency 16, so the matching can be performed at the agency. (Transmission of sought-for facial images, per se, to the credentialing agency is also possible, but currently impractical in most situation due to bandwidth constraints. These constraints are expected to be reduced in the near future.)

Distributed facial pattern matching is also possible. For example, if the FR algorithm used by the credentialing agency generates 50 eigenvalue vectors to characterize a face, 40 of these can be sent by the agency to the intermediary 14. The intermediary can then identify the subset of faceprints in its database that most closely match these 40 vectors, and then transmit faceprints for this subset (or just the ambiguous 10 vectors for each face) to the agency. The credentialing agency can then conduct the final facial matching operation, using the 10 vectors not provided to the intermediary.

In addition to checking new applicants for photo IDs against an existing library of sought-for faces, the system can likewise be employed in checking new sought-for faces against existing libraries of photo ID faces.

In the example just given, the FBI sent a new facial image to the intermediary 14. In addition to entering corresponding data in the database 14a, the intermediary can go further, and dispatch the new sought-for image (or corresponding faceprint data) to each of the credentialing agencies 16. Each agency can then check the new sought-for face against its internal database of facial images of existing ID holders, and respond to any suspect matches by reporting details of same to the intermediary or other agency for possible follow-up.

One particular embodiment has the intermediary 14 assemble a collection of newly-added sought-for images over a period of time (e.g., a day), and send this collection to each credentialing agency periodically. The agencies can then conduct the requested screening in a batch-mode, whenever their resources are available (e.g., after business hours).

This system 10 can also be used by law enforcement officers in the field. At a traffic stop, or otherwise, the officer typically solicits the person's driver's license. The officer can use one or more sensors to obtain data from the license. One sensor can be an image capture sensor that obtains a digital counterpart to the printed photo. This digital counterpart can then be processed to yield a faceprint corresponding to the license photo. Again, this faceprint can be screened against information in database 14a for possible matches.

In one arrangement, the officer has a reader device that is equipped with an image sensor, a processor, and a communications interface. This device can be a unit mounted in the officer's vehicle, or it can be a handheld device.

Vehicle-mounted units can include card scanners that capture data from the license in a highly controlled environment. In addition to optical scan data corresponding to the license photo, such units may also capture graphic symbologies (e.g., 2D bar codes), text, and mag stripe data. An associated processor can process this data in known ways, e.g., to verify that the various forms of data conveyed by the license are consistent with each other. If the data is not self-consistent, the officer is alerted (e.g., a red light).

Suitable handheld devices includes PDAs using Intel's X-Scale processors and wireless capabilities (e.g., 802,11(g), Bluetooth, government or commercial cellular radio networks). Others suitable handheld devices include camera-equipped cell phones. Again, these devices can be configured (by suitable programming instructions, and peripherals if needed) to provide functionality like that of vehicle-mounted units.

In an illustrative arrangement, when the officer captures an image of the license photograph, the image data is sent to the officer's agency 22 (e.g., regional police agency), which computes the corresponding faceprint. Again, as before, the entire faceprint can be relayed to the intermediary 14 for matching, or only selected parts of the faceprint may be sent—and a subset of candidate faceprint data can be returned to the agency 22 for final screening.

Often, the process of deriving and checking FR data is initiated only if the officer has reasonable grounds for suspicion (e.g., a ‘red light’ outcome in the driver's license inspection, or other unusual circumstances).

Capturing facial data from the license is subject to various optimizations. One is for the license to convey—or reference—previously-computed faceprint data. That is, when the license was originally obtained, the issuing agency may have routinely computed a faceprint for the captured photo, and encoded the faceprint among the machine readable data conveyed by the card. Or the agency may have encoded an identifier in the card's machine readable data by which faceprint data stored at a remote database (e.g., maintained by the DMV) may be indexed and accessed. Such arrangements are desirable because such faceprints are of high quality—having typically been computed from a high resolution digital image captured under carefully controlled circumstances.

In some cases, the license may convey a digital representation of the photographic image itself, e.g., in a storage medium portion of the license.

Photographs on many state driver licenses are digitally watermarked using IDMarc technology available from the present assignee, Digimarc Corporation. The processor in the reading device can identify the watermark and extract information. Some of this information is useful in characterizing affine distortion of the image—as would be introduced if the card were imaged obliquely by a cell phone camera. By knowing the affine distortion, subsequent processing of the image can take into account such distortion in computation of the faceprint. (E.g., the distortion can be removed, or the faceprint algorithm can be adjusted to compensate for the known distortion.)

Again considering the cell phone case, if the captured image includes the edges of the card, known edge-finding algorithms can be utilized to identify the boundaries of the card, and thereby infer the affine distortion introduced by oblique imaging. (I.e., if the card is imaged orthographically, the each pair of parallel edges will be of the same length, and will meet adjoining edges at right angles. Any difference in length, or difference in angles, can be used to characterize—and deal with—the imaging distortion, to enhance accuracy of the resulting faceprint data. Still further, visual fiducials, and other markings of known geometry and/or position can be used to infer object perspective, and thus affine distortion.)

As before, the different processing operations (e.g., characterizing affine distortion, filtering, compression, watermark reading, faceprint computation, etc.) can be distributed among various elements of the system, in whatever manner best exploits the capabilities of the different components.

In some embodiments, the officer may alternatively, or additionally, capture a photograph of the person being stopped—rather than relying just on the small photo printed on the license. Again, FR screening can be applied—if warranted—to compare the imaged face with those in database 14a.

Both in capturing image data from a card, and from a face, known algorithms can be applied to optimize exposure and composition of the image. Such techniques are detailed, for example, in various of the documents referenced herein.

The arrangements just-described find applicability beyond traffic stops. Similar methods can be employed in other contexts where photo IDs are presented, e.g., at airport check-in (presentation of driver's license or passport), when truckers entering secure ports or other facilities, etc.

Although the arrangements depicted have all focused around the intermediary 14, this is not always essential. Consider an officer who has scanned a driver's license, and found that the machine-readable data isn't self-consistent. The name printed on the license may say John Smith, but data watermarked in the card photo may indicate a different name. In this case the officer knows something is amiss, and time may take a new urgency.

Instead of screening the facial information against the entire database 14a, the protocol may instead first send the facial information to the DMV and state police in the state which is indicated—by machine-readable information detected on the card—as having issued the card. (If part of the data inconsistency is identification of different states in different machine readable data, then the facial information can be sent to DMVs and state police in two or more states.) These databases may well have information that will aid the officer, e.g., in ascertaining the true identity of the person stopped, and may be able to provide same more quickly than an exhaustive search through the central database 14a. (And the state or DMV databases may well have information not found in the central database 14a.)

Thus, in many arrangements it may be desirable to dispatch facial or other data to several databases for checking, rather than relying on just database 14a.

The Amber Alert system can also employ the technology detailed herein. When a suspected child kidnapping occurs, facial images (or simply faceprints) of the child can be entered in the database 14a, and can be immediately dispatched to all participating agencies 16, 22.

Likewise, the system is useful in reuniting runaways with their families. If a young man applies for a driver's license in one state, it may quickly be discovered that a person of the same appearance was recently reported missing in another.

Additional technology whose use is contemplated in connection with the arrangements herein described is detailed in published patent applications 20040243567 (which claims priority to application 60/451,840, filed Mar. 3, 2003), 20050065886, 20040133582, and 20040049401.

To provide a comprehensive disclosure without unduly lengthening this specification, applicants incorporate by reference the patents and other documents referenced in this specification (with the exception of any part of application Ser. No. 11/112,965 which was not disclosed in its priority application 60/564,820; and any part of publication 20040243567 that was not disclosed in its priority application 60/451,840).

Having described and illustrated the principles of our inventive work with reference to several different embodiments and methods, it will be recognized that the technology is subject to a great number of other variations.

For example, while the foregoing has focused on use of facial image data as an identifier, other biometric technologies can be used instead, or in addition. Some of these other technologies include fingerprints, iris scans, retinal scans, vein-prints, and skin textures.

### Face Recognition

Introduction

The two core problems in face recognition (or any other pattern recognition task) are representation and classification. Representation tackles the problem of measuring and numerically describing the objects to be classified. Classification seeks to determine which class or category an object most likely belongs to. Whatever their application domain, almost all pattern recognition problems differ primarily in their representation—the techniques used in classification can be used on the output of any representation scheme and are common to all pattern recognition domains (such as optical character recognition, information retrieval, and bioinformatics). The two tasks are sometimes bundled together algorithmically but are usually separable.

Representation

Representation, or parameterization, is the process of extracting, measuring, and encoding in a template an object's distinguishing characteristics, which are in turn used to train or query a generic classifier. Although this process is also referred to as “feature extraction” in the pattern recognition literature, the term “feature” is reserved here for its more specific face recognition meaning, viz., a part of the face (mouth, forehead, eye, etc.). The purpose of representation is to provide training data or queries to the face matching or face classification engine that will allow it to distinguish between individuals or classes. Generally, it attempts to compress as much useful information into as few parameters as possible since classification algorithms may become inefficient or intractable as the representation set increases in size. Perhaps less obviously, the utilization of too much or excessively detailed or irrelevant information in training can lead to overfitting and degrade the classifier's generalization accuracy. On the other hand, the representation should contain enough information to enable the classifier to distinguish between many faces or classes.

The various approaches to representation are described and discussed below. They may be neatly categorized in at least three different ways: by facial coverage (holistic or local), by source data type (image-based or geometric), and by facial dimension (2D or 3D). In general, earlier methods approached face recognition as a 2D problem and performed well for controlled conditions and few classes. However, none are very robust. For example, holistic approaches in general benefit from their use of face-wide information but are not invariant to illumination or pose. Local methods are better at handling these problems but are, by their very nature, limited information methods. More recent methods have attempted to measure or estimate 3D facial structures in order to obtain more robust recognition results-the separate discussion of 3D methods below reflects their novelty.

Geometric

Most early methods attempted to quantify the structure of the face by identifying key points (e.g., corner of eye, tip of nose, edge of forehead, etc.) and measuring the distances between them (Kelly, 1970; Brunelli and Poggio, 1993). A more recent structural approach, the Active Shape Model (ASM) (Cootes, et. al., 1995), performs Principal Components Analysis (PCA, explained in more detail below) on the coordinates of the key points for a set of training faces. The resulting principle components, or eigenvectors, encode the most important sources of facial variation and are used to compute a set of scores for faces to be recognized.

Geometric methods are simple and lighting invariant but their performance is obviously sensitive to variations in pose. Since the automatic identification of corresponding points on different faces can also be a problem, relatively few points are used in practice.

Holistic Image-Based

Holistic approaches seek to mimic the way the human brain initially recognizes faces, i.e., by forming a single overall impression of the face (as opposed to noting, say, the distance between the eyes or the size of the nose). Unlike the geometric or structural approaches mentioned above, image-based approaches use as inputs the pixel intensity values of facial images. Most models in the intersection of holistic and image-based approaches center on what are called “eigenfaces” (Kirby and Sirovich, 1990; Turk and Pentland, 1991).

In accordance with one method, eigenfaces are generated by performing PCA (or the Karhunen-Loeve transform) on the pixel covariance matrix of a training set of face images. The resulting eigenvectors form an orthogonal basis for the space of images, which is to say that every training image may be represented as a weighted sum of the eigenvectors (or “eigenfaces”, if rasterized). Given a test or query image, the system approximates it as a linear combination of the eigenfaces—difference in the values of the eigenface weights are used by the classifier to distinguish between faces.

Since there is a great deal of inter-pixel dependence in the covariance matrix, most facial variation can be captured by a relatively small number of eigenfaces. Discarding the rest as noise, the most important eigenfaces form a new reduced-dimension space which efficiently encodes facial information and allows the model to generalize, i.e., to identify faces that are similar overall and ignore (hopefully) unimportant differences between images of the same person. How many eigenfaces to retain is a question of balance: too many eigenfaces learn the details and the model fails to generalize; too few and its discriminating power is weakened.

Eigenface methods have been shown to work well in controlled conditions. Their holistic approach makes them more or less insensitive to noise, small occlusions, or modest variations in background. Using face-wide information, they are also robust to low resolution (recall that details are discarded as noise in any case). However, they are not invariant to significant changes in appearance (such as pose, aging, or major occlusions) and especially to illumination intensity and angle.

The eigenface technique may be extended by using some other set of vectors as a basis, such as independent components. A generalization of PCA, Independent Components Analysis (ICA) (Oja, et. al., 1995) extracts the variability not just from the covariances but from higher order statistics as well. The resulting basis vectors, while functionally similar to eigenvectors, are statistically independent, not just uncorrelated. The use of higher order statistics potentially yields a set of basis vectors with greater representative power but also requires more computation time.

The set of basis vectors may also be chosen using a genetic algorithm (GA) (Mitchell, 1996; Liu and Wechsler, 2000), a machine learning algorithm consisting of large numbers of sub-programs that “compete”, are “selected”, and “reproduce” according to their “fitness” or ability to solve the problem (in this case, their ability to differentiate the many classes from each other). Occasional “mutations” stimulate the continued search for new solutions as the “population” of sub-programs “evolves” to an improved set of basis vectors. Note that, unlike other representative approaches, this one is not separable from the subsequent classification task for it is the latter that provides “fitness” feedback to the GA.

It should be mentioned in passing that it is possible to represent an image by its unprocessed pixel intensity values, which can in turn be fed directly to a classifier.

Local Image-Based

In Local Feature Analysis (LFA) (Penev and Atick, 1996), feature templates or filters are used to locate the characteristics of specific facial features (eyes, mouth, etc.) in an image. The features are extracted and their locations, dimensions, and shapes quantified and fed into a classifier. Local features may also be extracted and parameterized in the same manner as are eigenfaces—the application of PCA to sub-regions of interest yields what may be called “eigeneyes” and “eigenmouths”, etc.

The detection of particular shapes is often efficiently accomplished in the frequency domain, the Gabor transform being particularly useful for locating and representing local features (Potzsch, et. al., 1996). The Gabor transform is a sort of normal curve-windowed Fourier transform that localizes its region of support in both spatial and frequency domains. Using a number of Gabor “jets” as basis vectors, the system extracts facial features and represents the face as a collection of feature points, much as the human visual system does.

Because they focus on detailed local features, local image-based methods require high-resolution images as input. However, their use of structural information makes them relatively robust to variations in illumination.

A variation on this approach is Elastic Bunch Graph Matching (EBGM) (Wiskott, et. al., 1999). EBGM first computes “bunches” of Gaborjets at key locations and then performs a flexible template comparison.

Classification

The task of a classifier in pattern recognition is to compute the probability (or a probability-like score) that a given pattern or example (here, a face) belongs to a pre-defined class. It accomplishes this by first “learning” the characteristics (the parameters of the templates that were computed during the representation step) of a set of “labeled” training examples (i.e., examples of known class membership) and saving them as a “class profile”. The template parameters of new query patterns or examples of unknown class membership are then compared to this profile to yield probabilities or scores. The scores are used in turn to determine which class—if any—the query pattern likely belongs to. In spatial terms, classifiers seek to find hyperplanes or hypersurfaces that partition the template parameter space into separate class subspaces.

Four major approaches to classification are presented below—all have been used in face recognition applications. They are discussed in order of increasing flexibility and, generally, decreasing ease of training.

Discriminant

One of the simplest classification routines is Linear Discriminant Analysis (LDA). In LDA, a discriminant function projects the data such that the classes are linearly separated (as much as possible) in template parameter space. LDA is fast and simple.

Based on statistical learning theory (Vapnik, 1998), the Support Vector Machine (SVM) is a fairly recent method that has been shown to be both accurate and (using a linear kernel) quick to train. Like LDA, the SVM finds a hypersurface in template parameter space that separates training examples as much as possible. While the LDA computes the separator based on the locations of all training examples, however, the SVM operates only on examples at the margins between classes (the so-called “support vectors”). The SVM can accommodate nonlinear kernels, in effect separating classes by hypersurfaces. Nonlinear kernels, of course, can take much longer to train.

Probabilistic

Most probabilistic classifiers use Bayes' formula to estimate the probability that a given template belongs to a specific class—the estimation is based on conditional probabilities (the probabilities of observing the template among all possible templates of the various classes) and prior probabilities (the probabilities, given no other information, of encountering examples from the classes). In the most common version, the templates are found or assumed to be distributed according to a particular probability density function (PDF), typically normal. “Training” in this case consists of collecting the statistics (such as mean and variance) of a set of training examples for each of the several classes. Given the PDF parameters and a query template, the conditional probabilities can be easily estimated for each class.

A Bayesian approach can easily accommodate non-sample information (e.g., in the form of educated guesses) and is therefore well suited to sets with small sample sizes. Under certain plausible assumption and using Parzen windows, for example, it is even possible to “train” a Bayesian classifier with one template per class.

Neural

Neural networks have been found to be a very powerful classification technology in a wide range of applications. Mimicking the densely interconnected neural structure of the brain, neural networks consist of multiple layers of interconnected nodes with nonlinear transfer functions. Input values are weighted at each connection by values “learned” in training, summed, warped, passed on to one or more “hidden” layers, and finally to an output layer where the scores are computed.

The power of a neural network lies in its ability to model complex nonlinear interdependencies among the template parameters and to approximate arbitrary PDFs. Neural networks can be expensive to train in batch mode but can also be trained incrementally. Unfortunately, their tendency to overfit the training data, the danger of convergence to local error minima, and the inexact “science” of neural architecture design (i.e., determining the optimal number and structure of layers, nodes, and connections) combine to demand a problem-specific handcrafted trial-and-error approach.

As suggested previously, an image's pixel intensity values may be passed directly (or with local averaging to reduce noise) to a classifier. Used in this manner, neural networks in effect force the task of representation onto the hidden layers.

Method Combination

One intuitive and easy-to-implement approach is to wire together two or more classifiers in parallel and/or in series. In the parallel case, the scores or probabilities of the several classifiers are fed to another classifier (loosely defined) that votes on, averages, or in some other way combines them. Although any standard classifier (e.g., probabilistic, neural) can serve as the combination engine, a simple averager has been found to work surprisingly well in many cases. In series, it may sometimes be advantageous to use an inexpensive classifier to winnow out the best candidate examples in a large set before using more powerful classifiers.

The use of method combination has been motivated by diminishing returns to classifier extension and refinement even as it has been made possible by desktop computing power unimaginable when face recognition was a nascent field. There is no guarantee that this approach will produce dramatic improvements, especially if the upstream classifiers are already accurate. If the classifiers are of distinctive paradigms, however, method combination will tend to take advantage of their differing strengths and return more accurate results.

### REFERENCES

(parentheticals indicate web addresses where copies of the cited documents can be found)

Blanz, V., and T. Vetter (1999), “A Morphable Model for the Synthesis of 3D Faces”, SIGGRAPH '99 Conference Proceedings (graphics.informatik.uni-freiburg.de/people/volker/publications/morphmod2.pdf)

Brunelli, R., and T. Poggio (1993), “Face Recognition: Features versus Templates”, IEEE Transactions on Pattern Analysis and Machine Intelligence, 15 (women.cs.uiuc.edu/techprojectfiles/00254061.pdf)

Buntine, W. (1994), “Operations for Learning with Graphical Models”, Journal of Artificial Intelligence Research, 2 (auai.org)

Cootes, T., C. Taylor, D. Cooper, and J. Graham (1995), “Active Shape Models—Their Training and Application”, Computer Vision and Image Understanding, 61 (isbe.man.ac.uk/˜bim/Papers/cviu95.pdf)

Kirby, M., and L. Sirovich (1990), “Application of the Karhunen-Loeve Procedure for the Characterization of Human Faces”, IEEE Transactions on Pattern Analysis and Machine Intelligence, 12 (camelot.mssm.edu/publications/larry/k1.pdf)

Liu, C., and H. Wechsler (2000), “Evolutionary Pursuit and its Application to Face Recognition”, IEEE Transactions on Pattern Analysis and Machine Intelligence, 22 (computer.org/tpami/tp2000/i0570abs.htm)

Mitchell, Melanie (1996), An Introduction to Genetic Algorithms, MIT Press.

Penev, P., and J. Atick (1996), “Local Feature Analysis: A General Statistical Theory for Object Representation”, Network: Computation in Neural Systems, 7 (neci.nec.com/group/papers/full/LFA/)

Potzsch, M., N. Kruger, and C. von der Malsburg (1996), “Improving Object Recognition by Transforming Gabor Filter Responses”, Network: Computation in Neural Systems, 7 (ks.informatik.uni-kiel.de/˜nkr/publications.html)

Romdhani, S., V. Blanz, and T. Vetter (2002), “Face Identification by Matching a 3D Morphable Model Using Linear Shape and Texture Error Functions”, Proceedings of the 9^{th} European Conference on Computer Vision (graphics.informatik.uni-freiburg.de/publications/list/romdhani_eccv02.pdf)

Turk, M., and A. Pentland (1991), “Eigenfaces for Recognition”, Journal of Cognitive Neuroscience, 3 (cs.ucsb.edu/˜mturk/Papers/jcn.pdf)

Vetter, T., and V. Blanz (1998), “Estimating Coloured 3D Face Models from Single Images: An Example-Based Approach”, Proceedings of the 5^{th} European Conference on Computer Vision, Vol. 2 (graphics.informatik.uni-freiburg.de/publications/estimating98.pdf)

Wiskott, L., J. Fellous, N. Kruger, and C. von der Malsburg (1999), “Face Recognition by Elastic Bunch Graph Matching” in L. C. Jain, et. al. (eds.), Intelligent Biometric Techniques in Fingerprint and Face Recognition, CRC Press (cnl.salk.edu/˜wiskott/Projects/EGMFaceRecognition.html)

Zhao, W., and R. Chellappa (2002), “Image-based Face Recognition: Issues and Methods”, in B. Javidi (ed.), Image Recognition and Classification, Mercel Dekker (cfar.umd.edu/˜wyzhao/publication.html)

Zhao, W., R. Chellappa, A. Rosenfeld, and J. Phillips (2002), “Face Recognition: A Literature Survey”, University of Maryland Technical Report CS-TR4167R (cfar.umd.edu/˜wyzhao/publication.html)

We claim:

1. A method comprising:
(a) imaging a driver's license using a handheld wireless device, thereby generating image data;
(b) identifying an excerpt of said image data corresponding to a facial photograph printed on the license;
(c) generating facial recognition parameters from said excerpt; and
(d) identifying possible matches in a database of facial data, by reference to said facial recognition parameters.

2. The method of claim 1 that includes determining an affine distortion of said image data, and wherein (c) includes taking said affine distortion into account in generating said facial recognition parameters.

3. The method of claim 2 that includes determining affine distortion by reference to watermark data.

4. A method comprising:
collecting facial image data corresponding to sought-for persons, from a plurality of different agencies;
for each, computing faceprints using plural different algorithms, resulting in plural faceprints;
storing the plural computed faceprints for each sought-for person in a database;
receiving faceprint data corresponding to a person not known to be sought-for, said received faceprint data having been computed according to a first algorithm; and
checking a subset of said stored faceprints that were computed using said first algorithm, for correspondence with said received faceprint.

5. A method practiced by a law enforcement officer, comprising:
using a handheld wireless device, capturing image data corresponding to a person stopped by the officer;
processing the captured image data to enhance its utility as a reference from which a faceprint can be derived;
generating a faceprint from the processed image data; and
checking a collection of previously-stored faceprints for correspondence with said generated faceprint.

6. The method of claim 5, wherein said processing includes adjusting contrast.

7. The method of claim 5, wherein said processing includes removing affine distortion.

8. The method of claim 5, wherein said processing includes identifying locations of the eyes in the captured image data.

9. The method of claim 5, wherein said processing includes cropping.

10. The method of claim 5, wherein said device can also be used for voice telecommunication.

11. In a method of issuing state driver's licenses that includes capturing facial portrait data from an applicant, and checking a collection of previously stored facial image data to determine whether a license has previously been issued to a person of similar appearance, an improvement that includes generating a faceprint data from the captured facial portrait data, and sending at least a portion of said faceprint data to another entity for screening against facial data of sought-for persons.

12. The method of claim 11 that includes receiving from said entity a collection of candidate faceprints that have a similarity with said sent faceprint data, and conducting a further screen of said candidate faceprints using faceprint data not provided to said entity.
